(19) United States
(12) Patent Application Publication
(10) Pub. No.: US 2025/0291203 A1
(43) Pub. Date: Sep. 18, 2025

(54) SMART GLASSES AND MANUFACTURING METHOD THEREFOR

(71) Applicant: BEIJING SUPERHEXA CENTURY TECHONOLOGY CO., LTD., Beijing (CN)

(72) Inventors: Erwei Huo, Beijing (CN); Lijun Li, Beijing (CN); Ke Chen, Beijing (CN); Zunzhao Liu, Beijing (CN); Tianwei Yao, Beijing (CN); Liming Zhai, Beijing (CN); Yongfeng Xia, Beijing (CN)

(73) Assignee: BEIJING SUPERHEXA CENTURY TECHONOLOGY CO., LTD., Beijing (CN)

(21) Appl. No.: 18/838,231

(22) PCT Filed: Sep. 30, 2022
(86) PCT No.: PCT/CN2022/123625

§ 371 Date: Aug. 13, 2024

(30) Foreign Application Priority Data
Oct. 8, 2021 (CN) 202111168559.1

(51) Int. Cl. G02C 5/14; G02C 11/00

(52) U.S. Cl. CPC G02C 5/146; G02C 11/10

(57) ABSTRACT

Smart glasses and a manufacturing method wherein a cavity comprising a first and second opening is provided in a temple of the smart glasses. A panel matches with the first opening in shape, and closes the first opening in front of the temple. A circuit board is fixedly connected to the panel and extends backwards from the panel. The panel matches with the cavity in shape. An electrical contact is provided on the circuit board. When the circuit board is inserted into a predetermined position of the cavity from the first opening, the electrical contact faces the second opening and extends out of the second opening. By using this structure, the mounting structure of the smart glasses is simplified while an elastic interface that is convenient to connect is provided, thus the convenience of mounting and manufacturing the smart glasses is improved.

### CROSS-REFERENCE TO RELATED APPLICATION

This application is a Section 371 National Stage Application of International Application No. PCT/CN2022/123625, filed on Sep. 30, 2022, entitled “Smart glasses and a manufacturing method therefor”, which claims priority to Chinese Application No. 202111168559.1, filed on Oct. 8, 2021, incorporated herein by reference in their entirety.

### TECHNICAL FIELD

The present disclosure relates to the field of smart equipment/intelligent equipment. Specifically, it relates to smart glasses and a manufacturing method therefor, and in particular to a pair of head-mounted smart glasses with temples and its manufacturing method.

### BACKGROUND

Wearable smart devices, for example, smart watches, smart bracelets, smart glasses, etc., have been widely and commonly used at present. Among them, smart glasses have the characteristics of easy image presentation and convenient use, and have become more and more popular with consumers.

Accordingly, the functional requirements for smart glasses are increasing. However, due to the limit in the shape of glasses, it is difficult for smart glasses to carry so many circuits, batteries and structures. Furthermore, products in the form of helmets or similar shapes are easy to cause troubles when wearing, thus limiting their application.

In addition, as the functions of smart glasses become richer, their structure becomes more and more complex, and the manufacturing difficulty becomes higher and higher. This leads to rising cost, low production efficiency and inconvenience in maintenance. Therefore, it needs a kind of smart glasses that can be easily worn and manufactured.

### SUMMARY

The present disclosure is proposed based on the above-mentioned requirements in the background. The technical problem to be solved by the present disclosure is to provide a pair of smart glasses and a manufacturing method thereof, so as to conveniently install rich/various smart structures in a limited glasses space.

In order to solve the above technical problem, the technical solutions in the present disclosure include:

A pair of smart glasses, comprising:
temples, wherein at least one temple is provide with a cavity therein, a first opening is provided in a front surface of the cavity, and a second opening is provided in a side surface of the cavity;
a panel, matching the first opening in shape and closing the first opening in front of the temple,
a circuit board, fixedly connected to the panel and extending backward from the panel, wherein the panel matches the cavity in shape; an electrical contact is provided on the circuit board, and the electrical contact has elasticity in an inner-outer direction; when the circuit board is inserted from the first opening into the cavity, the electrical contact is compressed under a pressure from a side wall of the temple; when the circuit board is inserted from the first opening to a predetermined position of the cavity, the electrical contact faces the second opening and extends out of the second opening.

According to some embodiments of the present disclosure, the electrical contact is connected to the circuit board by a spring.

According to some embodiments of the present disclosure, a receiving groove is provided in the circuit board, and the electrical contact is slidably received in the receiving groove.

According to some embodiments of the present disclosure, the second opening is arranged in an inner side of the temple.

According to some embodiments of the present disclosure, the temple further comprises a third opening arranged in a rear wall of the temple, the circuit board comprises an interface arranged in the third opening.

According to some embodiments of the present disclosure, a front end of the temple protrudes outward and downward to form the cavity; the cavity gradually narrows upward and inward from front to back; and a rear end of the temple is provided with a bending portion cooperating with an ear root.

According to some embodiments of the present disclosure, the circuit board is attached to a wall of the cavity at the rear of the cavity.

According to some embodiments of the present disclosure, it further comprises an optical device arranged on a front surface of the panel.

According to some embodiments of the present disclosure, the temple comprises a first temple and a second temple, and the first temple and the second temple are connected to each other through a crossbeam.

According to some embodiments of the present disclosure, the temples comprise a first temple and a second temple;
the first temple and the second temple are formed substantially symmetrically, a first cavity is provided in the first temple, a second cavity is provided in the second temple, both the first cavity and the second cavity are provided with said first opening facing forward, and at least one of the first cavity and the second cavity is provided with said second opening;
the panel comprises a first panel and a second panel, the first panel closes the first cavity in front of the first temple, and the second panel closes the second cavity at the second temple;
the circuit board comprises a first circuit board and a second circuit board, the first circuit board extends backward from the first panel, and the second circuit board extends backward from the second panel.

According to some embodiments of the present disclosure, the crossbeam comprises a front crossbeam portion and a rear crossbeam portion, the first panel and the second panel are fixedly connected to the front crossbeam portion; the first temple and the second temple are fixedly connected to each other through the rear crossbeam portion; the front crossbeam portion and the rear crossbeam portion are arranged in a front-rear direction to form the crossbeam with a hollow passage;
an electric wire is provided in the passage to connect the first circuit board with the second circuit board.

In addition, the present patent further discloses a method for manufacturing the pair of smart glasses according to any one of above embodiments, comprising: obtaining the temples; obtaining the panel and the circuit board; inserting the circuit board fixedly provided with the panel into the cavity of at least one temple.

According to some embodiments of the present disclosure, the method includes: obtaining a first module, obtaining a second module; inserting the first module into the second module, and fixing the first module and the second module.

According to some embodiments of the present disclosure, the obtaining the first module comprises fixing an optical machine and a camera to the front crossbeam portion.

According to some embodiments of the present disclosure, optical components of the optical machine and the camera are arranged on the front surface of the front crossbeam portion; and control circuit boards of the optical machine and the camera are arranged on the rear surface of the front crossbeam portion.

By adopting the above technical solutions, the installation/mounting structure of the glasses is simplified under the condition of providing an elastic interface for convenient connection, thereby improving the convenience of installing and manufacturing the glasses.

### BRIEF DESCRIPTION OF THE DRAWINGS

In order to more clearly illustrate the technical solutions in the embodiments of the present disclosure or the prior art, the drawings required for description of the embodiments or the prior art will be briefly introduced below. Obviously, the drawings described below only reflect some of the embodiments of the present disclosure, and other drawings can be obtained by those skilled in the art based on these drawings.

FIG. 1 is a structural view of one temple of the smart glasses in a specific embodiment of the present disclosure;

FIG. 2 is a schematic view showing the assembly of one temple of the smart glasses in a specific embodiment of the present disclosure;

FIG. 3 is a schematic view showing the assembly process of the temple in a manufacturing method of smart glasses in a specific embodiment of the present disclosure;

FIG. 4 is a schematic view showing the end of the assembly process of the temple in a manufacturing method of smart glasses in a specific embodiment of the present disclosure;

FIG. 5 is a structural view of the smart glasses in a specific embodiment of the present disclosure;

FIG. 6 is a structural view of the front half of the smart glasses in a specific embodiment of the present disclosure;

FIG. 7 is a structural view of the rear half of the smart glasses in a specific embodiment of the present disclosure;

FIG. 8 is a schematic view showing the assembly of the front and rear parts of the smart glasses in the present disclosure;

FIG. 9 is a schematic view showing the connection between the contacts and the circuit board of the smart glasses in the present disclosure.

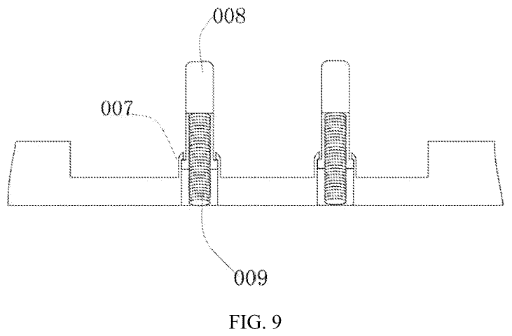

### DETAILED DESCRIPTION OF EMBODIMENTS

In order to make the purpose, technical solutions and advantages of the embodiments of the present disclosure clearer, the technical solutions in the embodiments of the present disclosure will be clearly and completely described in combination with the drawings in the embodiments of the present disclosure. Obviously, the described embodiments are just part of the present disclosure, not represent the whole of the present disclosure. Based on the embodiments in the present disclosure, other embodiments that may be obtained by those skilled in the art without creative work fall within the scope of protection of the present disclosure.

In order to facilitate the understanding of the embodiments of the present disclosure, the following specific embodiments will be further explained in combination with the drawings. The embodiments do not constitute a limitation on the present disclosure.

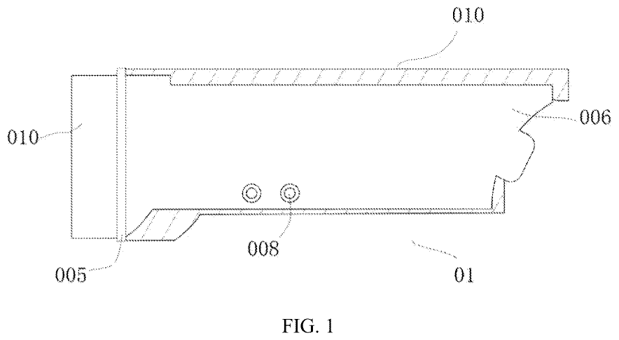

In these specific embodiments, the front, rear, left, right, top and bottom of the smart glasses are exemplarily defined as follows: As shown in FIG. 1, the direction of the smart glasses toward the human eyes is defined as the rear, and the opposite direction away from the human eye is defined as the front; the direction of the smart glasses toward the top of the head is defined as the top, and the direction toward the feet is defined as the bottom; the side of the smart glasses close to the face is defined as the inside, and the side away from the face may be the outside. It should be noted that the definitions of up, down, inside, outside, front, and rear will be different depending on the reference system. Therefore, the above-mentioned definitions of positions are used as examples in the present disclosure to facilitate the description of the technical solution of these specific embodiments.

In these specific embodiments, the smart glasses first have the form of glasses, that is, the glasses understood by ordinary technicians, and their notable feature is that they include temples, including a left temple and a right temple, which are respectively arranged on both sides of the face, and the temples are placed on the upper part of the ear roots of the person through brackets bent downward at the rear side of the temples. The left temple and the right temple are connected by a crossbeam, and the crossbeam is arranged across the width of the face. A nose pad is arranged on the crossbeam to support the front end of the glasses at the nose, preferably at the bridge of the nose, so as to form a glasses structure that can be stably mounted/worn on the face.

In these specific embodiments, the smart glasses may include lenses or not. If lenses are provided, the lenses are preferably a pair connected to the crossbeam. In these specific embodiments, the lenses can be detachably connected.

Smart glasses are called smart/intelligent because their main functions in these specific embodiments include intelligent functions, such as taking pictures or displaying through a near-eye display device. In addition to taking pictures and near-eye display, the smart glasses can optionally include the function of touch operation, for completing other functions such as computer program instructions.

Due to the form of glasses, which is significantly different from products such as eye masks and helmets, the weight and space size of smart glasses are obviously limited. However, as consumers' demand for smart functions increases, devices such as batteries and processors need to be supported by more powerful modules (taking “taking pictures” function as an example, the requirements for the performance of taking pictures lead to the increasing size of the components of the camera), which inevitably leads to an increase in size and an increase in the complexity of the system. But as a result, it forms a main contradiction between the convenience of manufacturing and the comfort of wearing glasses.

### Embodiment 1

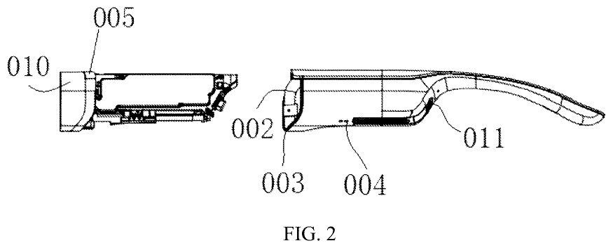

This embodiment provides a pair of smart glasses 01, whose structure is shown in FIGS. 1 to 4.

In these specific embodiments, the smart glasses include: temples 001, a cavity 002 is provided in the temple, a first opening 003 is provided in the front surface of the cavity, a second opening 004 is provided in the side surface of the cavity, and the second opening is provided in the inner side of the temple. The front end of the temple protrudes outward and downward to form the cavity; the cavity gradually narrows upward and inward from front to back; the rear end of the temple is provided with a bending portion that cooperates with the ear root. By forming the temple in a basically integral manner, the number of parts can be reduced and the difficulty of assembly can be reduced. In this embodiment, the cavity is formed in the front part of the temple, so that it does not affect wearing and can provide a relatively large space to accommodate corresponding circuit components.

There is provided a panel 005, it closes the first opening in front of the temple. The panel matches the shape of the first opening, so that a basically closed interior can be formed in the temple to form the appearance of the glasses. Optical devices 010, such as a camera and/or an optical machine, may be provided on the panel, thereby supporting the functions of the smart glasses.

In conjunction with the optical device 010, a circuit board 006 is also provided on the rear surface of the panel, the circuit board is fixedly connected to the panel and extends backward from the panel; the shape of the panel matches the shape of the cavity, and the circuit board is inserted into the cavity from the first opening. By inserting/plugging-in, the smart glasses can be conveniently manufactured, the manufacturing difficulty of the smart glasses is reduced, and the yield and manufacturing efficiency are improved.

In these specific embodiments, the circuit board matches the cavity in shape, that is, the circuit board fits the cavity as much as possible, so that the volume of the temple is reduced, and the wearing experience of the smart glasses is improved.

In smart glasses, a universal USB interface may generally be used for communication and charging, but multiple uses of one interface also bring troubles, for example, it has inability to use the communication function during charging, the size of the charging interface is large during charging, the adjustment space is not strong, or a small and portable charging box cannot be used. Therefore, in these specific embodiments, the temple is provided with a second opening 004 and a third opening 011, and charging or communication can be performed not only from the second opening but also from the third opening. However, multiple interfaces require a larger installation space, which causes troubles in the layout of the circuit.

For this reason, in these specific embodiments, one interface is provided in the second opening in the form of two electrical contacts, and another interface is provided in the third opening in the form of a universal USB interface.

The use of electrical contacts minimizes the space occupied. However, how to install the contacts is a technical problem, especially in the assembly mode of plug-in, the reason is that the contacts need to protrude out of the surface of the circuit board, and in order to reduce the volume, the circuit board and the cavity in the temple need to fit as closely as possible, and the protruding contacts make plug-in impossible.

For this reason, in this embodiment, a receiving groove 007 is provided in the circuit board, and the contacts 008 are slidably received in the receiving groove. The electrical contacts have elasticity in the inner-outer direction (a direction from inner to outer); the contacts and the circuit board are connected by springs 009. The circuit board is in contact with the wall of the cavity at the rear of the cavity.

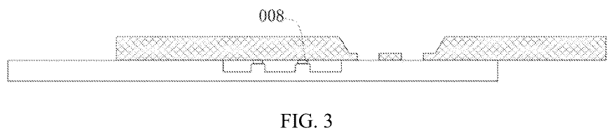

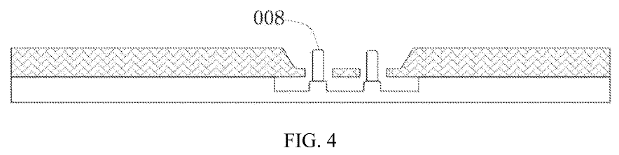

When the circuit board is inserted into the cavity from the first opening, the contacts are compressed by the side wall of the temple, as shown in FIG. 3; when the circuit board is inserted into the predetermined position of the cavity from the first opening, the contacts 108 face the second opening and extend out of the second opening, as shown in FIG. 4.

In this way, the contacts can also be assembled into the cavity of the temple together with the circuit board, which not only saves space on the circuit board, but also improves the convenience of installation.

### Embodiment 2

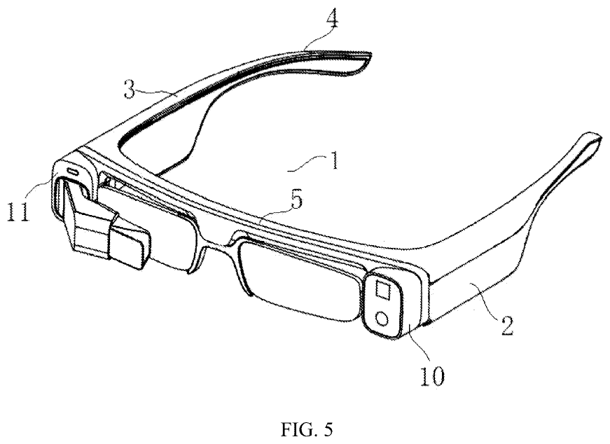

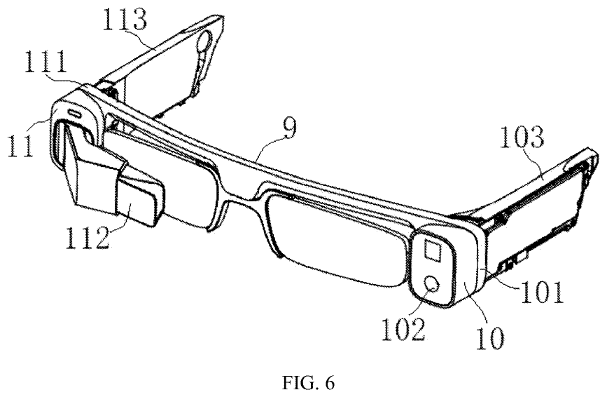

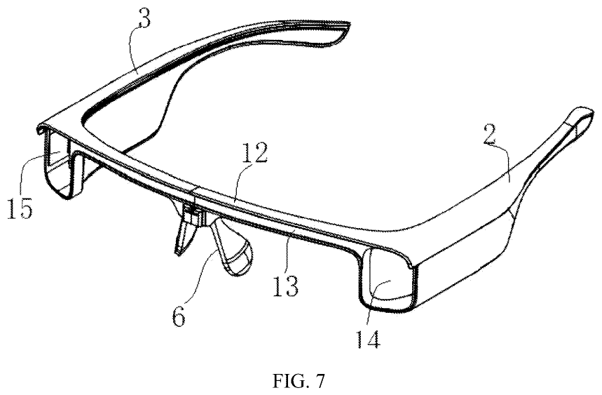

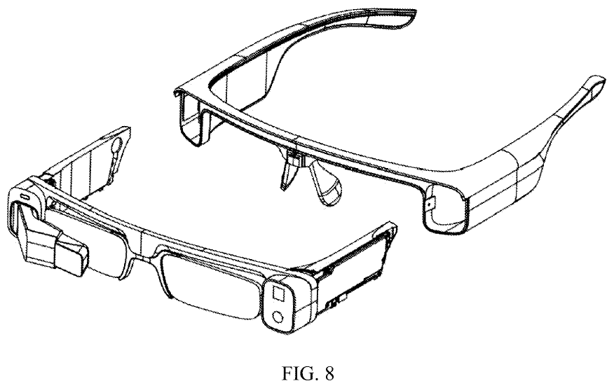

The main difference between the smart glasses 1 provided in this embodiment and the Embodiment 1 is that the two temples in the Embodiment 2 are arranged symmetrically and are connected together with a crossbeam with circuit boards at both ends by plug-in. The structure is shown in FIGS. 5 to 8.

In this embodiment, the smart glasses 1 first have the form of glasses, that is, the glasses as understood by ordinary technicians, and their notable feature is that they include temples, including a left temple 2 and a right temple 3, which are respectively arranged on both sides of the human face, and the temples are placed on the upper part of the person's ear roots through the brackets 4 bent downward on the rear side of the temples. The left temple 2 and the right temple 3 are connected by a crossbeam 5, which is arranged across the width of the human face. A nose pad 6 is provided on the crossbeam to support the front end of the glasses at the nose, preferably at the bridge of the nose, thus forming a glasses structure that can be stably mounted/worn on a person's face.

In this embodiment, the smart glasses include two modules (assemblies), front and rear modules, namely a first module 7 and a second module 8 (a first assembly and a second assembly). The assembly of the first module and the second module facilitates the manufacturing of the device.

As shown in the drawings, in these specific embodiments, the first module includes a front crossbeam portion 9, and a camera module/assembly 10 and an optical-mechanical module/assembly 11 respectively provided on the left and right sides of the front crossbeam portion.

The front crossbeam portion is a half area of the crossbeam, and is provided across the entire face. In these specific embodiments, the front crossbeam portion is formed into a plate shape as a whole, including a beam plate. The plate-shaped front crossbeam portion is convenient for carrying and installing optical-mechanical module and camera module, and can easily block the opening at the front end of the second module, to form a closed cavity structure inside the smart glasses.

On one side of the front crossbeam portion, the left side as shown in the drawings, a camera module 10 is provided. The camera module includes a panel 101, an optical device 102 and a control circuit board 103; the panel 101 and the front crossbeam portion are fixedly connected or integrally formed as a part of the front crossbeam portion. Preferably, the panel is provided at the left end of the front crossbeam portion. The panel and its attached frame are used as a supporting member to set up the camera module. Since there are no obstructions on the front and rear of the panel, in this case, setting up the above structure is easy to operate and implement during the manufacturing and assembly process.

In these specific embodiments, the optical device 102 of the camera is disposed outside the panel 101. In the camera, the optical device preferably includes a lens component, etc. Since the lens component needs to collect light from the external environment, it needs to be disposed on the outside of the panel, or at least face towards the outside of the panel. A control circuit board 103 is provided on the inner side of the panel assembly. The control circuit board may be a single circuit board or may be formed of multiple circuit boards, for example, a camera control circuit board, a battery, a main control chip of glasses, etc. The control circuit board can be packaged together as a whole, which is beneficial to maintaining the overall shape of the circuit board and facilitating assembly into the temples.

The optical-mechanical module 11 is disposed on the right side of the front crossbeam portion. The optical-mechanical module is a component used to provide near-eye display. Users wearing the smart glasses can observe images through the optical-mechanical module, and the images can also be superimposed to the real scenes to play the role of augmented reality. The optical-mechanical module/components can use components in the prior art, including optical lens assembly 112 (optical element), a display (not shown in the drawings) and a control circuit board 113. The control circuit board 113 controls the display to display the corresponding images, and transmit the images to the human eye through the optical lens assembly 112. In this specific embodiment, the optical elements of the optical-mechanical module are arranged on the outside of the right side panel 111 so as to extend to the front of the human eye. The control circuit board 113 of the optical-mechanical module also extends backward from the right side panel. Similarly, the control circuit board 113 may further include one or more circuit boards. Preferably, they are also packaged together in an integral package to maintain the overall shape of the circuit boards and facilitate assembly them into the temple.

In this specific embodiment, through the structure of the first module, the camera module and the optical-mechanical module can be installed on both sides of the front crossbeam portion without obstruction, making it easy to install components with complex mechanical structures and circuit structures, and improving the work efficiency.

In these specific embodiments, the smart glasses also include a second module/assembly 8. The second module includes a rear crossbeam portion 12. The rear crossbeam portion and the front crossbeam portion are arranged oppositely. The rear crossbeam portion is provided with a groove 13 which opens forward. When the front crossbeam portion and the rear crossbeam portion are relatively abutted, the front crossbeam portion and the rear crossbeam portion enclose and form a passage, connecting the left and right sides of the glasses. The passage can be used for wiring, thereby increasing the space for wiring. In this way, the thinner crossbeam can meet the wiring requirements; due to the large wiring space, relatively balanced structures can be set on the left and right sides of the smart glasses, and the communication on both sides can still be relatively smooth.

The second module further includes a first temple and a second temple, that is, a left temple 2 and a right temple 3, arranged on the left and right sides of the rear crossbeam portion. The first temple has a first cavity 14, the second temple has a second cavity 15; both side ends of the groove 13 of the rear crossbeam portion are communicated with the first cavity 14 and the second cavity 15, so that the wires in the first cavity or the second cavity can be conveniently led to the other side through the passage in the crossbeam.

In these specific embodiments, the first cavity and the second cavity are respectively provided in the temples on the left and right sides, and are located at the front of the temples. That is to say, in these specific embodiments, the temple is basically a whole body, and the cavity is provided inside the housing of the temple; through this arrangement, the temple can be manufactured basically as a whole, thereby reducing the number of assembled parts. In these specific embodiments, the inner side of the temples is basically horizontal; in order to increase the volume of the cavities, the first cavity and the second cavity are protruding outward from the temples on the left and right sides respectively, thus it will not affect wearing, and at the same time, it can increase the accommodation volume of the cavities to facilitate the installation of more complex and large-scale circuit structures.

The front ends of the first cavity and the second cavity have openings to facilitate the insertion of the components of the first module therein. At the rear of the first cavity and the second cavity, that is, at the middle of the temples, the cavities gradually narrow to smoothly transition to the brackets for the ear roots at the rear end of the temples. In these specific embodiments, the cavity is preferably gradually narrowed from bottom to top, in this way, it does not affect the experience of wearing glasses. In addition, the narrowed part can be used to set an opening to connect other devices other than the glasses to the glasses.

In the second module, the temples on the left and right sides are basically symmetrically arranged, and the shape and size of the first cavity and the second cavity are also basically the same and symmetrically arranged, which is beneficial to the balance when wearing the glasses, thereby improving the wearing experience.

The first module and the second module are combined together by plugging-in. Specifically, when the two are to be combined, the front crossbeam portion and the rear crossbeam portion are relatively close to each other, and the front crossbeam portion and the rear crossbeam portion face to each other to form a passage. The control circuit boards of the camera module and the optical-mechanical module on both sides of the first module are respectively inserted into the first cavity and the second cavity in the first temple and the second temple. In these specific embodiments, the shapes of the control circuit boards in the first cavity and the second cavity respectively match the shapes of the first cavity and the second cavity; after being plugged in, the cavity size of the temple can be as small as possible to reduce the weight of smart glasses and maintain a suitable shape. In the first module, the panels for the camera module and the optical-mechanical module respectively close the openings of the first cavity and the second cavity at the ends of the first cavity and the second cavity, so that an internal space is formed inside the glasses, the internal space is formed by the first cavity, the second cavity, and a pipe connecting the first cavity and the second cavity. Various circuit structures are provided in this internal space.

Because in the first module, there is no obstruction on the front and rear sides of the front crossbeam portion, it can be operated from both sides. When installing optical devices and control circuits, it is not limited by space and can be installed conveniently. The second module is mainly formed as an accommodation space. After the assembly of the first module is completed, the first module can be conveniently inserted into the accommodation space of the second module based on the positioning of the front and rear modules. In addition, in this embodiment, the space for accommodating the components of the smart glasses is not only sufficient but also balanced on the left and right. On the premise that the overall shape of the glasses is maintained, devices with better performance can be installed and the functions of the smart glasses can be optimized.

In smart glasses, a universal USB interface may generally be used for communication and charging, but multiple uses of one interface also bring troubles, for example, it has inability to use the communication function during charging, the size of the charging interface is large during charging, the adjustment space is not strong, or a small and portable charging box cannot be used. Therefore, in these specific embodiments, the temple is provided with a second opening and a third opening, and charging or communication can be performed not only from the second opening but also from the third opening. However, multiple interfaces require a larger installation space, which causes troubles in the layout of the circuit.

For this reason, in this specific embodiment, as in Embodiment 1, an interface is provided in the second opening in the form of two electrical contacts, and another interface is provided in the third opening in the form of a universal USB interface.

The use of electrical contacts minimizes the space occupied. However, how to install the contacts is a technical problem, especially in the assembly mode of plug-in, the reason is that the contacts need to protrude out of the surface of the circuit board, and in order to reduce the volume, the circuit board and the cavity in the temple need to fit as closely as possible, and the protruding contacts make plug-in impossible.

For this reason, in this embodiment, a receiving groove 007 is provided in the circuit board, and the contacts are slidably received in the receiving groove. The electrical contacts have elasticity in the inner-outer direction (a direction from inner to outer); the contacts and the circuit board are connected by springs 009. The circuit board is in contact with the wall of the cavity at the rear of the cavity.

When the circuit board is inserted into the cavity from the first opening, the contacts are compressed by the side wall of the temple, as shown in FIG. 3; when the circuit board is inserted into the predetermined position of the cavity from the first opening, the contacts face the second opening and extend out of the second opening.

In this way, the contacts can also be assembled into the cavity of the temple together with the circuit board, which not only saves space on the circuit board, but also improves the convenience of installation.

### Embodiment 3

This embodiment provides a method for manufacturing smart glasses. The method for manufacturing smart glasses in this specific embodiment is used to manufacture the smart glasses described in Embodiment 1.

In this Embodiment 3, the method includes the following steps:

S001 obtaining the first module

In this step, the first module may be an assembled first module. That is, the first module has been assembled with the front crossbeam portion, the camera module and the optical-mechanical module. In the first module, the optical machine (optical-mechanical module) and the camera are fixed on the front crossbeam portion; the optical devices of the optical machine and the camera are arranged on the front surface of the front crossbeam portion; the control circuit boards of the optical machine and the camera are arranged on the rear surface of the front crossbeam portion.

In addition to the above solutions, in this specific embodiment, obtaining the first module may further include assembling various parts into the first module, for example, assembling the optical-mechanical module and the camera module, and then fixing them to the front crossbeam portion.

During the manufacturing process, the first module is not interfered with by the front crossbeam portion in the front and rear directions, so that there is a large space for setting up a working mechanism or for manual operation, thus improving the convenience of assembly and improving work efficiency.

S002 obtaining the second module

In this step, the second module is the second module described in Embodiment 1. Obtaining the second module may include obtaining the structure of the second module that has been made, or may include the process of manufacturing the second module, for example, through mold manufacturing, three-dimensional printing, or assembly.

S003 inserting the first module into the second module, and fixing the first module and the second module.

In this step, the circuit board of the first module is inserted into the cavity of the second module, and the two half crossbeams of the first module and the second module, that is, the front crossbeam portion of the first module and the rear crossbeam portion of the second module are attached, and then the first module and the second module are combined together, thus forming a pair of smart glasses with an internal cavity for accommodating circuits.

In this embodiment, a modular assembly method is used to manufacture the smart glasses, which reduces the difficulty of assembly, facilitates assembly, and is beneficial to improving the assembly efficiency and product quality of the smart glasses.

The above-mentioned specific embodiments further describe the purpose, technical solutions and beneficial effects of the present disclosure in detail. It should be understood that the above-mentioned only reflects the specific embodiments of the present disclosure but are not intended to limit the scope of the present disclosure. Any modifications, equivalent replacements, improvements, etc. made within the spirit and principles of the present disclosure shall be included in the scope of protection of the present disclosure.

What is claimed is:

1. A pair of smart glasses, comprising:
temples, wherein at least one temple is provide with a cavity therein, a first opening is provided in a front surface of the cavity, and a second opening is provided in a side surface of the cavity;
a panel, matching the first opening in shape and closing the first opening in front of the temple,
a circuit board, fixedly connected to the panel and extending backward from the panel, wherein the panel matches the cavity in shape; an electrical contact is provided on the circuit board, and the electrical contact has elasticity in an inner-outer direction; when the circuit board is inserted from the first opening into the cavity, the electrical contact is compressed under a pressure from a side wall of the temple; when the circuit board is inserted from the first opening to a predetermined position of the cavity, the electrical contact faces the second opening and extends out of the second opening.

2. The pair of smart glasses according to claim 1, wherein the electrical contact is connected to the circuit board by a spring.

3. The pair of smart glasses according to claim 1, wherein a receiving groove is provided in the circuit board, and the electrical contact is slidably received in the receiving groove.

4. The pair of smart glasses according to claim 3, wherein the second opening is arranged in an inner side of the temple.

5. The pair of smart glasses according to claim 1, wherein the temple further comprises a third opening arranged in a rear wall of the temple, the circuit board comprises an interface arranged in the third opening.

6. The pair of smart glasses according to claim 1, wherein a front end of the temple protrudes outward and downward to form the cavity; the cavity gradually narrows upward and inward from front to back; and a rear end of the temple is provided with a bending portion cooperating with an ear root.

7. The pair of smart glasses according to claim 1, wherein the circuit board is attached to a wall of the cavity at the rear of the cavity.

8. The pair of smart glasses according to claim 1, further comprising an optical device arranged on a front surface of the panel.

9. The pair of smart glasses according to claim 1, wherein the temple comprises a first temple and a second temple, and the first temple and the second temple are connected to each other through a crossbeam.

10. The pair of smart glasses according to claim 9, wherein the temples comprise a first temple and a second temple;
the first temple and the second temple are formed substantially symmetrically, a first cavity is provided in the first temple, a second cavity is provided in the second temple, both the first cavity and the second cavity are provided with said first opening facing forward, and at least one of the first cavity and the second cavity is provided with said second opening;
the panel comprises a first panel and a second panel, the first panel closes the first cavity in front of the first temple, and the second panel closes the second cavity at the second temple;
the circuit board comprises a first circuit board and a second circuit board, the first circuit board extends backward from the first panel, and the second circuit board extends backward from the second panel.

11. The pair of smart glasses according to claim 10, wherein the crossbeam comprises a front crossbeam portion and a rear crossbeam portion, the first panel and the second panel are fixedly connected to the front crossbeam portion; the first temple and the second temple are fixedly connected to each other through the rear crossbeam portion; the front crossbeam portion and the rear crossbeam portion are arranged in a front-rear direction to form the crossbeam with a hollow passage;
an electric wire is provided in the passage to connect the first circuit board with the second circuit board.

12. A method for manufacturing the pair of smart glasses according to claim 1, comprising:
obtaining the temples;
obtaining the panel and the circuit board;
inserting the circuit board fixedly provided with the panel into the cavity of at least one temple.
